(19) United States
(12) Patent Application Publication
(10) Pub. No.: US 2005/0008014 A1
(43) Pub. Date: Jan. 13, 2005

(54) Techniques for network traffic engineering

(76) Inventors: Debasis Mitra, Summit, NJ (US); Iraj Saniee, New Providence, NJ (US); Anwar I. Walid, Watchung, NJ (US); Indra Widjaja, Florham Park, NJ (US)

Correspondence Address: Ryan, Mason & Lewis, LLP, Suite 205, 1300 Post Road, Fairfield, CT, 06824, US

(21) Appl. No.: 10/614,738

(22) Filed: Jul. 7, 2003

(51) Int. Cl. H04L 12/28

(52) U.S. Cl. 370/392; 709/238

(57) ABSTRACT

In a traffic engineering technique, a determination is made as to whether any path of a number of predetermined paths meets requirements corresponding to a request. The predetermined paths are determined by substantially maximizing carried demand using at least traffic demand estimates and network topology information and by performing routing for the substantially maximized carried demand. If a given path meeting the requirements is found, a connection on the given path is created, if possible. The predetermined paths are determined through offline TE techniques referred to herein as offline design-based routing (DBR). The requirements for the path may include a destination address and a bandwidth. The offline DBR techniques can include uncertain static demand information or dynamic connections. The offline DBR techniques may be used with adaptive DBR techniques, such that paths are determined offline if possible but can also use shortest path first (SPF), constrained SPF (CSPF) or other techniques during an online path determination. An improvement to a conventional CSPF technique is also presented.

### FIELD OF THE INVENTION

The present invention relates generally to communication over networks, and, more particularly, to determining effective paths through networks.

### BACKGROUND OF THE INVENTION

Traffic engineering (TE) systems attempt to control a network to provide an optimal usage of the network for the particular traffic demands experienced. A TE system in a connection-oriented network, where connections are made between source and destination nodes, can be generally classified as online or offline.

With an online TE system, connection requests are generally assumed to arrive one at a time. For each connection request, an online TE system typically computes each path independently without assuming knowledge of future requests. One common technique used to compute a path is shortest path first (SPF), which computes the shortest path between a source node and destination node. Another common technique is constrained SPF (CSPF), which first prunes a network so that links not meeting a bandwidth requirement for a connection request are removed, then the shortest path is chosen using the pruned network. After a path is determined, the connection is usually set up by signaling. The total provisioning time from when a connection request arrives to when a connection is established may take tens to hundreds of milliseconds. Thus, path determination in an online TE system must be relatively fast, e.g., on the order of milliseconds. Techniques such as CSPF can be “greedy” in that the path determined may be quite long and therefore use a large amount of resources in the network.

With an offline TE system, typically the aggregate behavior of all connection requests is assumed to be known before the corresponding paths are computed. Using topology information, link capacities and a traffic demand matrix, a centralized server typically performs global optimization to determine the path for each connection request. Once path design is completed, the connections are typically set up by a network management system. It is generally agreed that an offline system with global optimization can achieve considerable improvement in resource utilization over an online system, if the traffic matrix accurately reflects the real load the network will be required to carry. It is not generally understood how much benefit can be derived from an offline system that uses inaccurate load information. A need therefore exists to quantify the benefits of offline TE for operational networks in the absence of exact load information. In addition, the total pre-provisioning time with an offline system typically takes minutes or hours. Another problem with offline TE systems is that they typically need accurate demand information for the resultant paths to be accurate.

A need therefore exists to improve offline path computation techniques, with or without accurate demand information, for optimization in an online TE system.

### SUMMARY OF THE INVENTION

The present invention provides techniques for improved traffic engineering (TE) in connection-oriented networks, such as multiprotocol label switching (MPLS) or generalized MPLS (GMPLS). Techniques for online, offline, and combinations of online and offline computation techniques are disclosed.

In a first aspect of the invention, in response to a request, it is determined whether any path of a number of predetermined paths meets requirements corresponding to the request. The predetermined paths are determined by substantially maximizing carried demand in a network using at least traffic demand estimates and network topology information and by performing routing for the substantially maximized carried demand. The carried demand is generally a total amount of demand that can be carried in the network. If a given path meeting the requirements is found, a connection utilizing the given path is created, if possible. The predetermined paths are computed offline and routing that uses only the predetermined paths is referred to herein as offline design-based routing (DBR). The requirements for the path may be bandwidth and other constraints.

The traffic estimates may be determined using previously measured traffic demands or historical traffic demands or both, and the network topology may be determined by using information from link-state routing.

There are a number of techniques suitable for performing the substantial maximization and the routing. For instance, substantial maximization may be performed by obtaining a threshold that maximizes a number of connections that can be accepted and adjusting traffic demand for each of a number of node pairs in the network until the carried demand is substantially maximized. As another example, routing may be performed by minimizing a total bandwidth-length product subject to a number of constraints, such as edge capacity constraints and path-assignment constraints.

Additionally, offline DBR techniques can utilize uncertain static demand information. The path-assignment constraints may therefore comprise constraints that constrain a sum of an amount of demand in units of path capacity to be greater than a first product. The first product is a multiplication between a threshold and a second sum. The second sum is a sum of an average demand and a second product. The second product is a multiplication between a number indicating a distance from a standard deviation and a standard deviation of a normal distribution function.

An offline DBR technique may also utilize dynamic connections. Routing therefore may comprise minimizing a total bandwidth-length product subject to a number of constraints including edge capacity constraints. The edge capacity constraints may include constraining end-to-end blocking probability for a node pair to be less than a predetermined amount. As another example, routing may comprise determining a threshold minimum capacity assigned for a node pair that will meet a given blocking probability.

In yet another aspect of the invention, an offline DBR technique is combined with one or more adaptive DBR techniques, which can compute a path online should a path computed offline be deemed unsuitable for use. The adaptive DBR techniques may include determining whether a designed load between source and destination nodes is greater than a measured load between the source and destination nodes. If so, edges that do not have a first available bandwidth are pruned from the network topology. If not, edges that do not have a second available bandwidth are pruned from the network topology. The available bandwidths include, but are not limited to, trunk reservations. A first pruned network is created by the pruning. If a path meeting the requirements is found, a connection on the path is set up, if possible. If no path is found, then edges that do not have a first available bandwidth are pruned from the first pruned network to create a second pruned network, a shortest path from the source node to the destination node in the second pruned network is determined, and a connection on the shortest path is attempted to be created. Generally, the first available bandwidth is zero and the second available bandwidth is a predetermined trunk reservation.

In another aspect of the invention, a modification of a conventional constrained shortest path first (CSPF) technique is presented. In this exemplary online computation technique, a first shortest path between a source node and destination node is determined. Edges not having a first available bandwidth are pruned from the network, thereby creating a first pruned network. A second shortest path is computed between the source node and the destination node using the first pruned network. If a length of the second shortest path is equivalent to a length of the first shortest path, a connection on the second shortest path is created, if possible. If the length of the second shortest path is not equivalent to a length of the first shortest path, then edges not having a second available bandwidth are pruned from the first pruned network, thereby creating a second pruned network. A third shortest path is computed between the source node and destination node using the second pruned network. A connection on the third shortest path is created, if available.

### BRIEF DESCRIPTION OF THE DRAWINGS

FIG. 1 is a block diagram of a communication system in accordance with a preferred embodiment of the invention;

FIG. 2 illustrates different classifications for routing;

FIG. 3 is a block diagram illustrating a framework for offline design based routing (DBR), which can be used in adaptive DBR systems;

FIG. 4 illustrates a method for offline path optimization for network traffic engineering;

FIG. 5 illustrates an example network topology used to show a benefit of path optimization for network traffic engineering;

FIG. 6 shows pseudocode of an exemplary method for adaptive DBR, which can combine online and offline network traffic engineering; and

FIG. 7 shows pseudocode of an exemplary method for online traffic engineering using a modified constrained shortest path first (CSPF) with trunk requirements (TRs) technique.

### DETAILED DESCRIPTION

For ease of reference, the present disclosure is divided into the following sections: Introduction; Path Design with DBR; and Routing With Resource Management.

Introduction

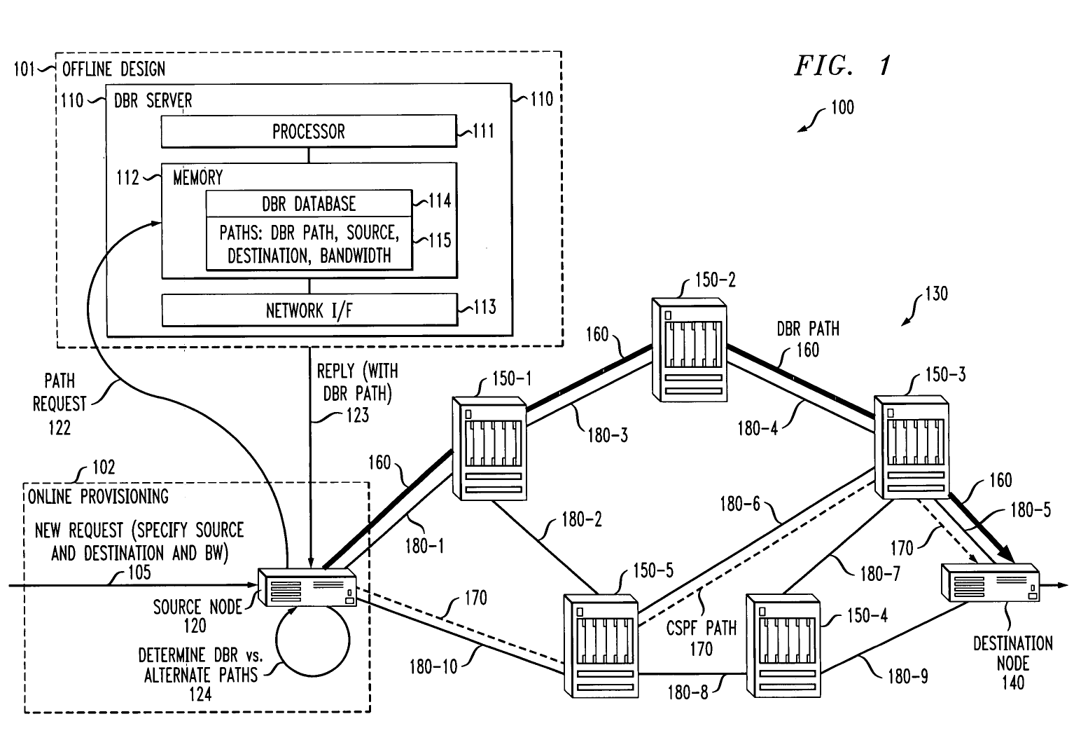

Referring now to FIG. 1, a communication system 100 is shown. Communication system 100 comprises a DBR server 110 coupled to a network 130. Network 130 comprises a source node 120, intermediate nodes 150-1 through 150-5, edges 180-1 through 180-10, and a destination node 140. DBR server 110 comprises a processor 111, memory 112 and network interface 113. The source node 120, destination node 140, and intermediate nodes 150 could be routers, switches, or other types of network elements. For purposes of exposition, the source node 120, destination node 140, and intermediate nodes 150 will be considered to be label switch routers (LSRs) or have an LSR portion (not shown) in addition to other portions. Memory 112 comprises a DBR database 114. DBR database 114 comprises a number of paths 115, each path 115 having a predetermined DBR path, source, destination, and bandwidth. The processor 111 executes one or more programs (not shown) in order to implement the techniques of the present invention. It should be noted that FIG. 1 only shows one source and one destination node for simplicity. In general, there will be a multiplicity of source and destination nodes.

In general, the offline design stage 101 is used to determine, using techniques described in detail below, paths 115 from a source node 120 to a destination node 140. This determination is performed offline. Paths 115 usually include bandwidth requirements. The paths 115 that are determined offline are used during the online provisioning stage 102. Broadly, a source node 120 desires, based on a connection request 105 from a client (not shown), a connection to another client (not shown) via the destination node 140. The connection request 105 usually comprises a source, destination, and bandwidth requirement, and may comprise additional constraints. The LSR portion of source node 120 then sends a path request 122 to the DBR server 110, requesting the “best” path to the destination node 140. The path request 122 generally includes the source, destination, and bandwidth requirement from the connection request 105. The DBR server 110 acts to comply with the path request 122 by determining a path in paths 115 that meets the requirement of the path request 122. The DBR server 110 sends a reply 123 to the source node 120. The reply generally includes a DBR path, such as DBR path 160. The path request 122 and reply 123 usually travel through network 130 or through a separate signaling network (not shown).

In an aspect of the invention, the LSR portion of the source node 120 will only use paths 115 that are predetermined through offline computation techniques. Upon receiving the reply 123, the LSR portion of the source node 120 will then attempt to setup the DBR path (e.g., DBR path 160) from the source node 120 to the destination node 140. The connection setup may be made through any suitable technique, such as through the RSVP-TE signaling protocol as described in RFC 3209, “RSVP-TE: Extensions to RSVP for LSP Tunnels,” (December 2001), the disclosure of which is hereby incorporated by reference. In the example of FIG. 1, the DBR path 160 is set up over edges 180-1, 180-3, 180-4 and 180-5. If there is no suitable path in paths 115, the DBR server 110 can send a reply 123 that includes a rejection of the path request 122. The offline computation techniques are referred to herein as offline DBR techniques.

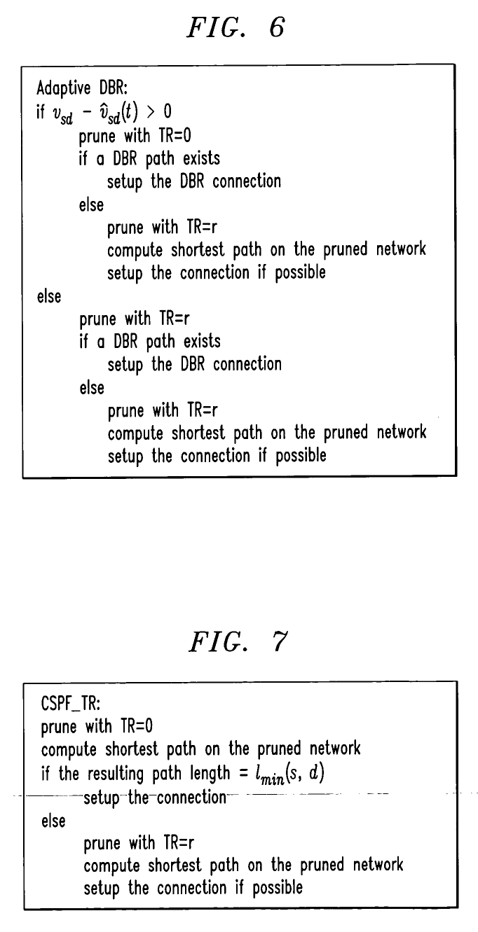

In another aspect of the invention, the LSR portion of the source node 120 first tries to use any paths 115 determined through offline DBR techniques but if the path is deemed unsuitable, can fall back to an online computation technique in order to determine an alternate path. For example, the constrained shortest path first (CSPF) path 170 may be determined and set up over edges 180-10, 180-6, and 180-5 if the DBR path 160 is deemed unsuitable. This is referred to as adaptive DBR herein and is explained in more detail below, for instance in reference to FIG. 6.

In another aspect of the invention, the LSR portion of the source node 120 uses only online TE techniques to respond to connection requests 105 and to create a path determined online. An example of an online TE technique is shown in reference to FIG. 7.

It should be noted that source node 120, destination node 140, and intermediated nodes 150 will also generally comprise a switch matrix and multiple network interfaces such as found in routers and switches. It should also be noted that edges 180 may be bidirectional. Additionally, network 130 may be any packetized or optical network design. Illustratively, network 130 may be network supporting multiprotocol label switching (MPLS) or generalized MPLS (GMPLS).

The techniques described herein may be implemented through hardware, software, firmware, or a combination of these. Additionally, the techniques may be implemented as an article of manufacture comprising a machine-readable medium, as part of memory 112 for example, containing one or more programs that when executed implement embodiments of the present invention. For instance, the machine-readable medium may contain a program configured to perform some or all of the steps of the present invention. The machine-readable medium may be, for instance, a recordable medium such as a hard drive, an optical or magnetic disk, an electronic memory, or other storage device.

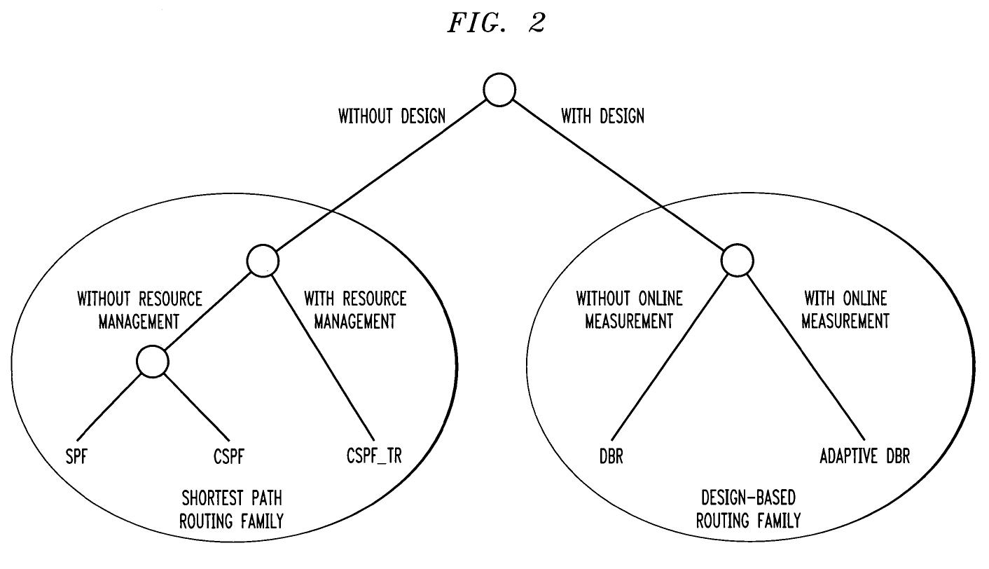

Turning now to FIG. 2, classifications of routing methods for TE are shown. The classifications are shown as a taxonomy, which is not intended to be exhaustive. However, FIG. 2 covers a broad array of schemes that make use of offline and online measurements, local and global optimizations, resource management schemes and signaling requirements. At a high level, the methods may be classified according to whether offline design optimization is used. The design-based routing family is distinguished by the use of an estimated traffic demand matrix and global path optimization. The shortest-path routing family involves certain shortest path computations, with or without resource management, for one source-destination pair at a time. In the present disclosure, the term “source” includes a source node, and the term “destination” includes a destination node. The routing algorithms in the shortest path family include the standard SPF and CSPF methods. In the present disclosure, an extension to this family is presented with resource management, which is an improved CSPF technique with trunk reservation (TR). The improved technique is shown as CSPF_TR.

The routing algorithms in the design-based routing family may be further grouped based on their use of online measurements. In DBR, optimally predetermined paths based on approximate knowledge of the demand matrix are used in setting all source-destination paths online. In the hybrid scheme, called adaptive DBR, online measurements are used to further improve path selection using admission control.

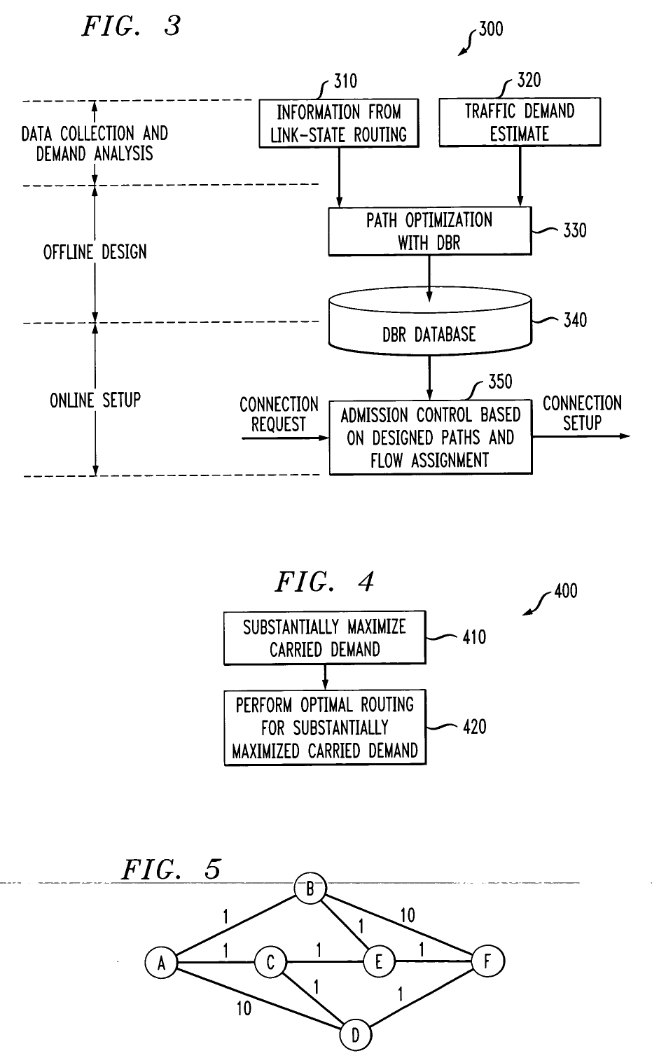

Turning now to FIG. 3, a framework 300 for offline DBR is shown. Framework 300 may also be considered to be a method for offline DBR. The framework 300 comprises information from link-state routing 310, traffic demand estimate information 320, a path optimization module 330 with DBR, a DBR database 340, and an admission control module 350. Note that 310, 320, 330 and 340 reside at the DBR server 110, while 350 resides in each source node 120 (e.g., having an LSR). The path optimization module 330 collects information from link-state routing 310 and traffic demand estimate information 320. The information from link-state routing 310 may comprise network topology, link capacities, and other relevant information such as constraints. The traffic demand estimate 320 is an estimate of traffic on a network.

Based on this input information, the optimization module 330 computes all optimized paths offline and stores the results in the DBR database 340 for future use. As described in more detail below, the DBR database 340 comprises a set of paths from each source node to each destination node and bandwidth allowed on each path. When an external connection request arrives from a source computer, the admission control module 350 would try to set up a connection to a specified destination. In non-adaptive DBR, admission control is only applied on a DBR path found in the DBR database 340. In other words, if there is no previously determined path in the DBR database 340 meeting the requirements in the connection request, the admission control module 350 rejects the connection request. In adaptive DBR, admission control is applied on a DBR as well as alternate (e.g., CSPF) paths. Consequently, in adaptive DBR, even though a path meeting the requirements in the connection request cannot be found, the admission control may perform an online technique in order to meet the connection request.

Non-adaptive DBR is described immediately below and adaptive DBR is described in the Routing With Resource Management section below.

Path Design with DBR

Techniques for TE using offline DBR are now described.

A. Definitions and Notations

A network topology is represented by a graph G(V, E), where V denotes the set of nodes (also called vertices) and E denotes the set of edges (also called links) and each edge, e ε E, has a capacity of Cₑ. It should be noted that a graph may be represented by any type of data, such as a linked list.

Length for a path may be a function of actual distance or other salient parameters used in the optimization criteria. Focus herein is placed on the optical transport network, where the edges and the connections are typically bi-directional. However, the techniques herein are applicable to non-optical transport networks. Demands, in terms of the number of bandwidth, vary from one source-destination pair to another. For an optical transport network, for instance, each connection may be considered to be a lightpath of the same size (e.g., one lambda).

Let K denote the set of all node pairs in the network. For static connections, the traffic demand, dₖ, is expressed in terms of the total bandwidth of connections that need to be routed for node pair k ε K. For dynamic connections, the traffic demand, δₖ, is the offered load in Erlangs for node pair k ε K. Let Pₖ denote the set of all paths for node pair k and let P denote the set of all paths for all node pairs; that is, P=∪ₖPₖ. The output of path design determines the amount of demand that needs to be assigned to each path. Let the quantity xₚ represent the amount of demand assigned to path p ε P. Finally, let Qₑ denote the set of all paths that traverse edge e. The subsequent sections present DBR formulations for a case with no protection (i.e., no restoration in case of edge failure).

B. DBR with Accurate Static Demand Information

A computer system implementing DBR determines all end-to-end paths concurrently and optimally using the network topology, edge capacities, traffic demand matrix and possibly other constraints. A path design objective is to minimize the total bandwidth-length product. Furthermore, the optimization problem is subject to meeting the designated end-to-end demands, from sources to destinations, while not exceeding the edge capacities. If all connections cannot be established in the existing network due the constraints implied by the fixed edges capacities, it is recommended that the problem be to be solved in two stages, as shown broadly in method 400 of FIG. 4. Method 400 is performed by a computer system, such as the traffic engineering server 110 shown in FIG. 1, in order to determine paths used later for routing connections. In Stage 1, step 410, a goal is to substantially maximize the carried demand in a network. The carried demand is the total amount of demand that can be carried in the network. It should be noted that substantially maximizing does not mean absolute maximization, although absolute maximization is beneficial. Thus, any technique that increases carried demand in a network is suitable for substantial maximization, although in general the closer to maximal the carried demand is, the better the overall result will be. In Stage 2, step 420, optimal routing is performed for the carried demand derived in Stage 1. These two stages may be formulated in different ways, as described in detail below.

One general formulation for Stage 1 is as follows:

$$\begin{matrix}P1 ( θ ) & \\ {max}_{{x}_{p} , {θ}_{p}} {\sum }_{k} {θ}_{k} {d}_{k} & ( 1 ) \\ subject to & \\ {\sum }_{p ∈ {P}_{k}} {x}_{p} \geq {θ}_{k} {d}_{k} , ∀ k ∈ K & ( 2 ) \\ {\sum }_{p ∈ {Q}_{e}} {x}_{p} \leq {C}_{e} , ∀ e ∈ E & ( 3 )\end{matrix}$$

xₚ≧0, ∀ₚ ε P (4)
0≦θₖ≦1, ∀ₖ ε K (5)

Having obtained the threshold θ*ₖ that maximizes the number of connections that can be accepted, the traffic demand is adjusted for each node pair k as d*ₖ←θ*ₖdₖ. It should be noted that Stage 1 optimization can be performed with a common demand multiplier for all node-pairs, i.e., θₖ=θ, ∀k, which will ensure a fair admission policy amongst all node-pair demands at the expense of reducing the overall carried traffic. Note that the set of all paths for all node pairs P have been computed and qualified at the outset. For example, for each node pair, the set of possible paths may consist of all paths with length less than the length of the shortest path plus some threshold value. In general, using very long paths for multicommodity flow problems has diminishing utility.

A Stage 2 optimization problem is as follows:

$$\begin{matrix}Q 1 ( λ * length ) & \\ {min}_{{x}_{p} , {λ}_{e}} {\sum }_{e ∈ E} {λ}_{e} {l}_{e} & ( 6 ) \\ Subject to & \\ {\sum }_{p ∈ {P}_{k}} {x}_{p} \geq {d}_{k} , ∀ k ∈ K & ( 7 ) \\ {\sum }_{p ∈ {Q}_{e}} {x}_{p} \leq {λ}_{e} , ∀ e ∈ E & ( 8 )\end{matrix}$$

λₑ≦Cₑ, {e εE (9)
xₚ≧0, ∀p ε P (10)
Equation set (8) is an equation set having path-assignment constraints, while equation set (9) is an equation set having edge capacity constraints.

It can be shown that the total demand met in Q1 is the same as the objective value of problem P1, however, the output of Q1 provides the assignments of demands to paths for each node pair (i.e., xₚ) with least cost packing. It can also be shown that when the edge capacities are large, the effect of performing this optimization is simply to let each node pair use the shortest path.

In this case, no concurrent optimization of all demands is necessary. Indeed, Q1 which is minimization of the total bandwidth-length product subject to edge capacity constraints, can be thought of as a simple non-trivial extension of the shortest path routing when there are capacity constraints on the edges.

The output of this integer linear program (ILP), or its rounded linear program (LP) relaxation, gives the paths and their allocated flows for each node pair. Clearly, the total bandwidth-length product of any other scheme is at best equal to the optimum value obtained above for a prescribed demand matrix. In particular, this is true for any online TE system, where each connection request is processed one at a time at each arrival, such as in SPF and CSPF. It can be shown that the optimum value determined through the above scheme is better than an online TE system.

In SPF, static edge weights are used for path computation, where the weight could be a function of distance, inverse of edge capacity (1/Cₑ), or other parameters. Arriving requests are continuously assigned to the computed paths although some edges may become saturated, resulting in blocking, while other edges may still be underutilized. To alleviate this lack of load balancing inherent in SPF, CSPF can use dynamic weights, such as the residual capacity (e.g., 1/(Cₑ−λₑ)) that reflects the current availability of the edge resources. CSPF clearly dominates SPF in many circumstances, but its utility vanishes rapidly as the total demand in the network increases. To summarize, if v(policy) denotes the optimal objective (such as carried demand) of a routing policy, then v(DBR)≧v(CSPF).

C. Value of Traffic Demand Information

It may be argued that the lack of optimality of online path computation is purely due to the non-optimal arrival sequence of connection requests in time. That is, if one could examine all possible permutations of arrival sequences, the optimal solution will simply follow by applying SPF/CSPF to that specific sequence. To see why solutions based on the optimal arrival sequence cannot match the solution to Q1, consider the simple example shown in FIG. 5. Here, each edge has capacity one unit (lambda) and length, or cost, as indicated in the figure. There are two connection requests, each needing one unit of capacity, between A and F to be routed. Observe that for SPF and CSPF, the paths are (A, C, E, F) and one of (A, B, F) or (A, D, F). Thus the total cost for SPF or CSPF is 14. However, the optimal paths would take (A, B, E, F) and (A, C, D, F), resulting in the total cost of 6. Furthermore, notice that no permutation of the arrival sequences in SPF or CSPF will result in the optimal paths. It can be concluded that the concurrency of path assignments afforded by optimization is a stronger factor for the best use of network resources than the order of arrivals or load balancing (e.g., CSPF). In other words, use of the traffic demand information and concurrent assignment of demands to routes enables better packing of the demands in the network in ways that even the best sequential solution, with or without load balancing, cannot match.

This concurrency in the design of paths (as enabled by DBR of the present invention) turns out to be an even more important factor for the effective use of network resources than the network load itself.

This is true whether load is interpreted in the static case with or without perfect information or in the dynamic case. The next section defines DBR in the context of uncertain traffic demand and dynamic connections.

D. DBR with Uncertain Static Demand Information

It is commonly argued that exact end-to-end demand information is almost never available in practice. Often, this argument is used erroneously to conclude that the class of purely online path computation schemes is the only suitable solution in practice, since this class does not require information about the end-to-end traffic demand matrix. It can be shown that, using techniques of the present invention, even demand information with considerable uncertainty can be utilized to give a better path design than can be computed by SPF or CSPF. To explore the uncertainty issue further, assume that \tilde{d}ₖ ε N(\overline{d}ₖ,σₖ) and reformulate P1/Q1 when end-to-end demands are no longer fixed but are random variables. The direct translation of the stochastic variant of P1 using point estimates of the random variable dₖ, ∀ₖ would not lead to the correct optimization model, however. This is because the carried load in a stochastic setting is the minimum of (i) the provisioned bandwidth and (ii) the offered load; in other words, min{Σ_{p ε P}_{ₖ}xₚ,Σₖθₖ\tilde{d}ₖ}. The condition set from equation set (2) with point estimates for dₖ only ensures that the mean provisioned demand exceeds the offered load. Therefore, this condition can be substituted with a more stringent requirement that the offered load is met with a high probability. Thus, Stage 1 optimization (i.e., step 410 of FIG. 4) in this setting becomes the following:

$$\begin{matrix}\tilde{P1} ( θ ) & \\ {max}_{{x}_{p} , {θ}_{k}} E \{ {\sum }_{k} {θ}_{k} {d}_{k} \} & ( 11 ) \\ subject to & \\ Pr \{ {\sum }_{p ∈ {P}_{k}} {x}_{p} \geq {θ}_{k} {d}_{k} \} , \geq 1 - {∈}_{k} , ∀ k ∈ K & ( 12 ) \\ {\sum }_{p ∈ {Q}_{e}} {x}_{p} \leq {C}_{e} , ∀ e ∈ E & ( 13 )\end{matrix}$$

xₚ≧0, ∀p ε P (14)
0≦θ≦1, ∀k ε K (15)
Equation set (13) is an equation set having edge capacity constraints.

It is noted that the constraint set in equation set (2) has been replaced with the equation set in equation set (12) which ensures, with arbitrarily high probability 1−εₖ, that the optimized fraction of the offered load is met. It is also noted that because of this constraint, the carried load, namely min{Σ_{p ε P}_{ₖ}xₚ,Σₖθₖ\tilde{d}ₖ}, is equal to Σₖθₖ\overline{d}ₖ which is the objective maximized. Given that dₖ˜N(\overline{d}ₖ,σₖ)∀k, the constraint set (12) can be simplified as

$${\sum }_{p ∈ {P}_{k}} {x}_{p} \geq {θ}_{k} ( {\overline{d}}_{k} + {η}_{k} {σ}_{k} ) \qquad ( 16 )$$

where
ηₖ=\sqrt{2}erf⁻¹(1−2 εₖ) (17)

$$erf ( x ) = \frac{2}{\sqrt{π}} {\int }_{0}^{x} {ⅇ}^{- {y}^{2}} ⅆ y \qquad ( 18 )$$

Equation set (16) is an equation set having path-assignment constraints.

It can be observed that over a long series of the realizations of the random demands, the above procedure will outperform any online scheme with the same requirements. In particular: E{v(DBR)}≧E{v(CSPF)}.

As in the deterministic formulation, better packing of the flows xₚ to paths p can be obtained from the equivalent model to Q1 obtaining θ* from P2:

$$\begin{matrix}Q 2 ( λ * length ) & \\ {min}_{{x}_{p} , {λ}_{p}} {\sum }_{e ∈ E} {λ}_{e} {l}_{e} & ( 19 ) \\ subject to & \\ {\sum }_{p ∈ {P}_{k}} {x}_{p} \geq {θ}_{k}^{*} ( {\overline{d}}_{k} + {η}_{k} {σ}_{k} ) ∀ k ∈ K & ( 20 ) \\ {\sum }_{p ∈ {Q}_{e}} {x}_{p} \leq {λ}_{e} , ∀ e ∈ E & ( 21 )\end{matrix}$$

λₑ≦Cₑ, ∀ₑ ε E (22)
xₚ≧0, ∀ₚ ε P (23)

It is noted that Q2 is a deterministic optimization problem and is feasible due to the resealing of demands derived from P2.

E. DBR with Dynamic Connections

When connections are dynamic, there is always a chance of blocking even with generous dimensioning of the paths. In this case, the DBR objective is to minimize network resource usage subject to meeting the traffic demand up to a given level of blocking probability. Variants of this problem have been considered in D. Resource-Sharing by Several Services,” in Proc. Int'l Zurich Seminar on Digital Communications, Lecture Notes in Comp, Sci., Broadband Communication Link, B. Plattner (editor), Springer, 173-185 (1996), the disclosure of which is hereby incorporated by reference, where three approaches were proposed: complete partitioning, complete sharing and virtual partitioning. For simplicity and clarity of the presentation, only complete partitioning will be described. However, DBR techniques disclosed herein are extensible to all three approaches.

Assume that connection requests between node pair k arrive according to a Poisson process with offered load δₖ, and a logical path with capacity Lₖ(=Σ_{p ε P}_{ₖ}xₚ) lambdas is assigned for node pair k. Then the end-to-end blocking probability for node pair k is given by the Erlang B formula

$$B ( {δ}_{k} , {L}_{k} ) = \frac{{δ}_{k} / {L}_{k} !}{{\sum }_{i = 0}^{{N}_{k}} {δ}_{i} / i !} \qquad ( 24 )$$

The optimization procedure for DBR with dynamic connections can be formulated as follows:

$$Q3 ( λ * length ) \\ min {\sum }_{e ∈ E} {λ}_{e} \qquad ( 25 )$$

subject to
B(δₖ,Lₖ)≦β, ∀k ε K (26)

$$\begin{matrix}{\sum }_{p ∈ {P}_{k}} {x}_{p} \geq {L}_{k} , ∀ k ∈ K & ( 27 ) \\ {\sum }_{p ∈ {Q}_{e}} {x}_{p} \leq {λ}_{e} , ∀ e ∈ E & ( 28 )\end{matrix}$$

λₑ≦Cₑ, ∀e ε E (29)
xₚ≧0, ∀p ε P (30)

Note that the non-linear constraint of equation set (26) can be eliminated by first solving for Lₖ. In this case, the optimization problem can be simplified by using the following procedure:

Q3 (λ*length)
1. Compute L*ₖ=arg min_{L}_{ₖ} {B(δₖ,Lₖ)≦β}, ∀k ε K.
2. Solve Q1 with dₖ←L*ₖ∀k ε K (using pre-processing P1 if necessary).

The formulation of DBR with protection (e.g., dedicated or shared) follows similar approaches presented in the preceding discussions. For details of these formulations and the computations of link capacities for the case of accurate static demand, see R. D. Davis, K. Kumaran, G. Liu, and I. Saniee, “SPIDER: A Simple and Flexible Tool for Design and Provisioning of Protected Lightpaths in Optical Networks,” Bell Labs Technical Journal, vol.6, no.1 (June 2001), the disclosure of which is hereby incorporated by reference.

Routing With Resource Management

This section presents an enhancement to the basic shortest path routing and design-based routing through the application of trunk reservation for managing bandwidth resources during congestion. It is well known that trunk reservation may be applied to two-hop paths to reduce resource usage. Here, the trunk reservation concept is generalized to an arbitrary network with CSPF or DBR routing.

An enhancement to the basic DBR scheme, called adaptive DBR, is intended to deal with inaccuracies in traffic demand forecast. A main idea of adaptive DBR is to use the current measured load for a given ingress-egress node pair as a surrogate to DBR. When the current measured load for a given node pair is lower than that used in the design of the DBR path, a connection request for the node pair will attempt to use the path given by DBR. On the other hand, when the current measured load is higher than that used in the design, a connection request can only use the path computed by DBR provided that the DBR path passes the trunk reservation test. In each case, a failed DBR path can fall back to CSPF with trunk reservation.

It is noted that adaptive DBR in an illustrative embodiment requires an online measurement component at each source node and an online path-selection component. For simplicity, the dynamic model with no protection is considered. The relevant notations will first be defined. Let v_{sd} be the designed load between s and d that is used in the computation of DBR paths. Let \hat{v}_{sd} be the current measured load between s and d.

Path selection for an exemplary adaptive DBR is shown in FIG. 6. When the designed load is greater than the current measured load, then the network is pruned using a trunk reservation of zero. If a DBR path exists, the DBR connection is setup (if possible). If no DBR path exists, then the network is pruned with a trunk reservation of r. A network is pruned with trunk reservation level r (i.e., TR=r) if any link with available bandwidth less than or equal to r is removed. The shortest path is computed on the pruned network, and the shortest path is setup if possible. When the designed load is less than or equal to the current measured load, then the network is pruned using a trunk reservation of r. If a DBR path exists, the DBR connection is setup (if possible). If no DBR path exists, then the network is again pruned with a trunk reservation of r. The shortest path is computed on the pruned network, and the shortest path is setup if possible.

Adaptive DBR is intended to improve upon offline DBR when the traffic demand forecast is inaccurate. If the demand is accurate, then adaptive DBR is generally the same as offline DBR.

Now, a technique called CSPF with trunk reservation (CSPF_TR) is described. The CSPF_TR is shown in FIG. 7. Let lₘᵢₙ (s, d) denote the minimum path length from source s to destination d computed through SPF. Then, the CSPF_TR scheme proceeds in a manner indicated in FIG. 7. The network is pruned with a trunk reservation of zero. The shortest path on the pruned network is determined. If the resulting shortest path is equivalent to lₘᵢₙ(s, d), then the path is set up (if possible). If the path length is not equivalent to lₘᵢₙ(s, d), then the network is pruned by using a trunk reservation of r. The shortest path on the pruned network is determined and the path is setup if possible.

The CSPF_TR of FIG. 7 provides short connections generally when network utilization is low, but also uses less resources than CSPF when network utilization is high. In particular, CSPF tends to use large amounts of resources when network utilization is high and CSPF_TR provides a better use of resources at high network utilization.

It is to be understood that the embodiments and variations shown and described herein are merely illustrative of the principles of this invention and that various modifications may be implemented by those skilled in the art without departing from the scope and spirit of the invention. The various assumptions made herein are for the purposes of simplicity and clarity of illustration, and should not be construed as requirements of the present invention.

1. A method for traffic engineering in a network-based communication system, the method comprising the steps of:
determining, in response to a request, whether any path of a plurality of predetermined paths meets at least one requirement corresponding to the request, wherein the plurality of predetermined paths are determined by substantially maximizing a carried demand on a network using at least traffic demand estimates and network topology information and by performing routing for the substantially maximized carried demand; and
if a given path meeting the at least one requirement is found, attempting to create a connection utilizing the given path.

2. The method of claim 1, wherein the carried demand comprises a total amount of demand that can be carried in the network.

3. The method of claim 1, wherein the at least one requirement comprises a destination address and a bandwidth.

4. The method of claim 1, further comprising the steps of:
determining the traffic demand estimates based at least in part on previously measured traffic demands or historical traffic demands; and
determining network topology by using information from link-state routing.

5. The method of claim 1, further comprising the steps of:
substantially maximizing the carried demand using at least the traffic demand estimates and the network topology;
performing routing for the substantially maximized carried demand, thereby determining a plurality of resultant paths; and
storing the plurality of resultant paths as the predetermined paths.

6. The method of claim 1, further comprising the step of:
refusing the connection request if there are no paths in the plurality of predetermined paths meeting the at least one requirement or when the connection utilizing the given path is unavailable.

7. The method of claim 1, wherein:
the network topology comprises nodes interconnected through edges;
the request is made by a source node;
the method further comprises the steps of:
determining whether a designed load between the source node and a destination node is greater than a measured load between the source and destination nodes;
when the designed load between the source node and the destination node is greater than a measured load between the source node and the destination node, pruning edges that do not have a first available bandwidth from the network, thereby creating a first pruned network; and
when the designed load between the source and a destination is not greater than a measured load between the source and destination, pruning edges that do not have a second available bandwidth from the network, thereby creating a first pruned network.

8. The method of claim 7, wherein the first bandwidth is zero and the second bandwidth is a predetermined trunk reservation.

9. The method of claim 7, wherein:
the steps of determining whether a designed load, pruning edges that do not have a first available bandwidth from the network, and pruning edges that do not have a second available bandwidth from the network are performed prior to the step of determining, in response to a request, whether any path of a plurality of paths meets at least one requirement; and
the method further comprises performing, if a given path meeting the at least one requirement is not found, the following steps:
pruning edges that do not have a first available bandwidth from the first pruned network to create a second pruned network;
computing shortest path from the source node to the destination node in the second pruned network; and
attempting to create a connection on the shortest path.

10. The method of claim 5, wherein:
the step of maximizing further comprises the steps of:
obtaining a threshold that maximizes a number of connections that can be accepted; and
adjusting traffic demand for each of a plurality of node pairs in the network until the carried demand is substantially maximized; and
the step of performing routing further comprises the step of minimizing a total bandwidth-length product subject to a plurality of constraints including edge capacity constraints and path-assignment constraints.

11. The method of claim 5, wherein the step of maximizing further comprises the step of maximizing the carried demand using at least traffic demand estimates and a graph of the network, subject to a plurality of first constraints.

12. The method of claim 11, wherein the plurality of first constraints comprise: (1) demand assigned to all paths for a selected node pair is greater than or equal to a demand corresponding to the selected node pair multiplied by a number to be maximized; (2) demand assigned to all paths traversing a selected edge is less than or equal to a capacity of the selected edge; (3) the demand assigned to a path is greater than or equal to zero; and (4) the number to be maximized is between zero and one.

13. The method of claim 5, wherein the step of performing routing further comprises the step of performing routing for the substantially maximized carried demand, subject to a plurality of second constraints.

14. The method of claim 13, wherein the plurality of second constraints comprise: (1) demand assigned to all paths for a selected node pair is greater than or equal to a demand corresponding to the selected node pair multiplied by a number to be maximized; (2) demand assigned to all paths traversing a selected edge is less than or equal to a bandwidth used by the selected edge; (3) the bandwidth used by a selected edge is less than or equal to a capacity of the selected edge; and (4) the demand assigned to a path is greater than or equal to zero.

15. The method of claim 5, wherein the step of maximizing comprises the step of maximizing a product of an expectation of a real number to be maximized and a demand, subject to having a mean provisioned demand exceed an offered load with a predetermined probability.

16. The method of claim 5, wherein the step of performing routing further comprises the step of minimizing a total bandwidth-length product subject to a plurality of constraints including path-assignment constraints.

17. The method of claim 16, where the path-assignment constraints comprise constraining a sum of an amount of demand in units of path capacity to be greater than a product of a threshold and a sum of an average demand and a product of a number indicating a distance from a standard deviation and a standard deviation of a normal distribution function.

18. The method of claim 5, wherein the step of performing routing further comprises the step of minimizing a total bandwidth-length product subject to a plurality of constraints, where the plurality of constraints include constraining end-to-end blocking probability for a node pair to be less than a predetermined amount.

19. The method of claim 5, wherein the step of performing routing further comprises the step of determining a threshold minimum capacity assigned for a node pair that will meet a given blocking probability.

20. The method of claim 5, wherein the step of performing routing further comprises the step of minimizing a total bandwidth-length product subject to a plurality of constraints including edge capacity constraints for which demand per node pair is assigned a threshold capacity.

21. An apparatus for traffic engineering for in a network-based communication system, the apparatus comprising:
a memory; and
at least one processor, coupled to the memory;
the apparatus operative:
to determine, in response to a request, whether any path of a plurality of predetermined paths meets at least one requirement corresponding to the request, wherein the plurality of predetermined paths are determined by substantially maximizing carried demand on a network using at least traffic demand estimates and network topology information and by performing routing for the substantially maximized carried demand; and
if a given path meeting the at least one requirement is found, to attempt to create a connection utilizing the given path.

22. An article of manufacture for traffic engineering in a network-based communication system, the article of manufacture comprising:
a machine readable medium containing one or more programs which when executed implement the steps of:
determining, in response to a request, whether any path of a plurality of predetermined paths meets at least one requirement corresponding to the request, wherein the plurality of predetermined paths are determined by substantially maximizing carried demand on a network using at least traffic demand estimates and network topology information and by performing routing for the substantially maximized demand; and
if a given path meeting the at least one requirement is found, attempting to create a connection utilizing the given path.

23. A method for traffic engineering for a network-based communication system comprising a network having nodes interconnected through edges, and wherein a source node requests a connection to a destination node, the method comprising the steps of:
determining a first shortest path between the source node and destination node;
pruning edges not having a first available bandwidth from the network, thereby creating a first pruned network;
computing a second shortest path between the source node and the destination node using the first pruned network;
if a length of the second shortest path is equivalent to a length of the first shortest path, attempting to create a connection on the second shortest path; and
if a length of the second shortest path is not equivalent to a length of the first shortest path, performing the following steps:
pruning edges not having a second available bandwidth from the first pruned network, thereby creating a second pruned network;
computing a third shortest path between the source node and destination node using the second pruned network; and
attempting to create a connection on the third shortest path.
